(19) United States
(12) Patent Application Publication
(10) Pub. No.: US 2026/0349800 A1
(43) Pub. Date: Nov. 5, 2026

(54) ACTUATOR WITH MEMORY RESOURCE

(71) Applicant: Micron Technology, Inc., Boise, ID (US)

(72) Inventor: Seshasai Vamsi Krishna Peddinti, Puppalguda (IN)

(21) Appl. No.: 19/639,747

(22) Filed: Apr. 6, 2026

Related U.S. Application Data
(60) Provisional application No. 63/800,037, filed on May 5, 2025.

(51) Int. Cl. G06F 9/50

(52) U.S. Cl. CPC G06F 9/5016

(57) ABSTRACT

Apparatuses, systems, and methods can be related to an actuator with a memory resource. An actuator device can include a processing resource and a memory resource having instructions written thereon and executable by the processing resource to cause an output torque for the actuator device to be determined based on locomotion input data associated with a locomotion device, the determined output torque to be provided to the actuator device, data associated with performance of the locomotion device to be obtained, and locomotion of the locomotion device to be smoothed using a model and based on the performance

### PRIORITY INFORMATION

This application claims the benefits of U.S. Provisional Application Number 63/800,037, filed on May 5, 2025, the contents of which are incorporated herein by reference.

### TECHNICAL FIELD

The present disclosure relates generally to memory, and more particularly to apparatuses, systems, and methods associated with an actuator with a memory resource

### BACKGROUND

Memory devices, also referred to as memory resources, are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. including, but not limited to personal computers, portable memory sticks, digital cameras, cellular telephones, portable music players such as MP3 players, movie players, and other electronic devices. Memory cells can be arranged into arrays, with the arrays being used in memory devices.

Artificial intelligence (AI) can be used in conjunction memory resources. AI can include a controller, computing device, or other system to perform a task that normally requires human intelligence. AI can include the use of one or more machine learning models. As described herein, the term “machine learning” refers to a process by which a computing device is able to improve its own performance through iterations by continuously incorporating new data into an existing statistical model. Machine learning can facilitate automatic learning for computing devices without human intervention or assistance and adjust actions accordingly.

An actuator, also referred to as an actuator device, is a component of a device that produces force, torque, or displacement when an electrical, pneumatic, or hydraulic input is supplied to it in a system. An actuator utilizes a control device and a source of energy, with displacement achieved in a linear motion and/or a rotational motion.

### BRIEF DESCRIPTION OF THE DRAWINGS

FIG. 1 is a block diagram of an apparatus in the form of a computing system including a memory resource in accordance with a number of embodiments of the present disclosure.

FIG. 2 illustrates a block diagram of an apparatus in the form of an actuator in accordance with a number of embodiments of the present disclosure.

FIG. 3 illustrates an example flow diagram of a method for torque determination in accordance with a number of embodiments of the present disclosure.

FIG. 4 illustrates a block diagram of a system including a locomotion device with an actuator in accordance with a number of embodiments of the present disclosure.

FIG. 5 illustrates a block diagram of a system including a locomotion device with actuators in accordance with a number of embodiments of the present disclosure.

FIG. 6 illustrates an example machine of a computer system within which a set of instructions, for causing the machine to perform various methodologies discussed herein, can be executed.

### DETAILED DESCRIPTION

The present disclosure includes apparatuses, systems, and methods related to an actuator with a memory resource. In various examples, an actuator in accordance with the present disclosure houses a memory resource and a processing resource, such that data can be processed at the actuator.

Exoskeleton devices, prosthetic devices, and other locomotion devices utilize high-torque actuators to provide necessary torque to complete various activities such as walking, running, and other everyday tasks. To replicate a human locomotion, large amounts of data need to be processed, and complicated models/algorithms need to be implemented. Data used in these models may require a compiler, for example, to compile and/or translate the data to be executable by a computing device, processing resource, memory resource, etc. An external microprocessor, for instance located on a user’s back, may be used to implement a human locomotive-based algorithm, such as an interconnection and damping assignment passivity-based control (IDA-PBC) model that provides data associated with the locomotion device.

In such approaches, actuators (e.g., of the locomotion device) do not house memory resources and/or processors. Because determining torque for an actuator can require large amounts of data and processing (e.g., processing complicated algorithms), due to the need to replicate human locomotion (e.g., walk or gait cycle) external processors and/or external controllers are used to store and process data. That is, in such approaches, processing and storing of data occurs at a location remote from the actuator itself. This does not allow for continuous processing and updating, in contrast to the present disclosure. Further, due to high temperature outputs of actuator components functioning of memory resources may be negatively affected, particularly high-torque actuators needed for devices such as prosthetic devices and exoskeleton devices.

In contrast, examples of the present disclosure include including a memory resource on an actuator (e.g., as part of a microcontroller) to allow for data processing and the implementation of complex algorithms. The actuator can function with an internal microprocessor rather than, or in addition to, an external microprocessor, and the memory resource can be used to store human data and further process it. For example, the memory resource may support implementation of AI-based large language models (LLM) to perform intensive data processing.

For instance, examples can include an actuator device located on a locomotion device such as a prosthetic device or an exoskeleton device, with the actuator housing a processing resource and a memory resource that can receive input data associated with the locomotion device, as well as internal sensors such as Hall-effect sensors and external sensors such as pressure sensors and/or inertial measurement unit (IMU) sensors. The input data can be analyzed utilizing models. A reasonable torque can be determined for the actuator, and torque can be iteratively smoothed and updated as more data is received and stored at the memory resource. This can allow for processing of large amounts of data and the use of complicated algorithms to improve functionality of the locomotion device. Additionally, the memory resource can include temperature sensors allowing it to function at higher temperatures without loss of data and/or functionality. For example, an internal sensor can be used to control the actuator in a more robust manner.

In some examples of the present disclosure, an actuator device can include a processing resource and a memory resource having instructions written thereon and executable by the processing resource to cause an output torque for the actuator device to be determined based on locomotion input data associated with a locomotion device, the determined output torque to be provided to the actuator device, data associated with performance of the locomotion device to be obtained, and locomotion of the locomotion device to be smoothed using a model and based on the performance

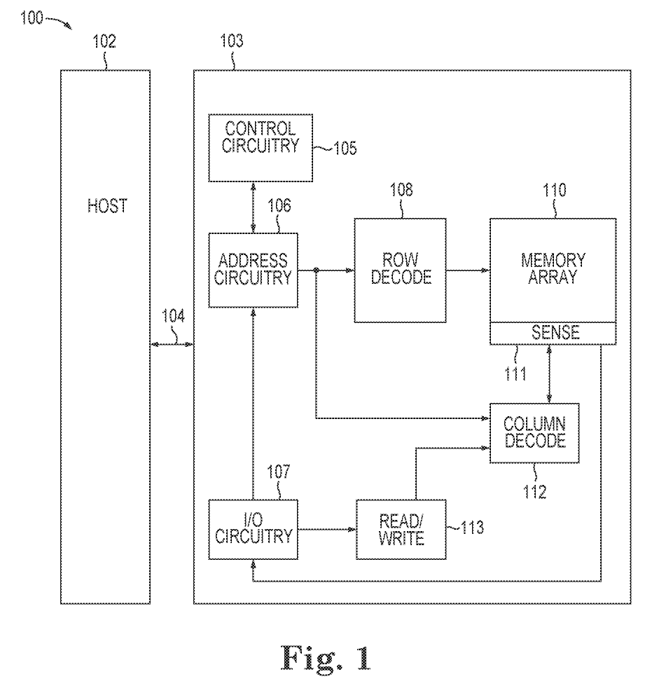

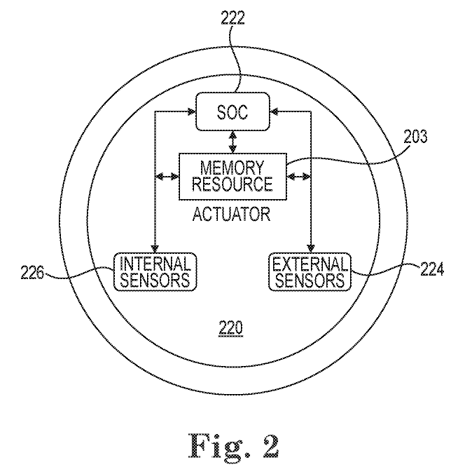

The figures herein follow a numbering convention in which the first digit or digits correspond to the drawing figure number and the remaining digits identify an element or component in the drawing. Similar elements or components between different figures may be identified by the use of similar digits. For example, 103 may reference element “03” in FIG. 1, and a similar element may be referenced as 203 in FIG. 2. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a block diagram of an apparatus in the form of a computing system 100 including a memory resource 103 in accordance with a number of embodiments of the present disclosure. As used herein, a memory resource 103, memory array 110, and/or a host 102, for example, might also be separately considered an “apparatus.”

In various examples, the computing system 100 includes a host 102 coupled to memory resource 103 via an interface 104, which may include I3C, non-volatile memory express (NVMe), or peripheral component interconnect express (PCie) protocols, for instance. The memory resource 103 can be coupled to a memory module which is coupled to the computing system 100 via the interface 104. The computing system 100 can be a personal laptop computer, a desktop computer, a digital camera, a mobile telephone, a memory card reader, or an Internet-of-Things (IoT) enabled device, among various other types of systems. The host 102 can include a number of processing resources (e.g., one or more processors, microprocessors, or some other type of controlling circuitry) capable of accessing the memory resource 103. The computing system 100 can include separate integrated circuits, or both the host 102 and the memory resource 103 can be on the same integrated circuit. For example, the host 102 may be a system controller of a memory system comprising multiple memory resources 103, with the system controller providing access to the respective memory resources 103 by another processing resource such as a central processing unit (CPU).

In the example shown in FIG. 1, the host 102 is responsible for executing an operating system (OS) and/or various applications that can be loaded thereto (e.g., from memory resource 103 via control circuitry 105). The OS and/or various applications can be loaded from the memory resource 103 by providing access commands from the host 102 to the memory resource 103 to access the data comprising the OS and/or the various applications. The host 102 can also access data utilized by the OS and/or various applications by providing access commands to the memory resource 103 to retrieve said data utilized in the execution of the OS and/or the various applications.

For clarity, the computing system 100 has been simplified to focus on features with particular relevance to the present disclosure. The memory array 110 can be a DRAM array, SRAM array, STT RAM array, PCRAM array, TRAM array, RRAM array, NAND flash array, NOR flash array, and/or 3D Cross-point array for instance. The memory array 110 can comprise memory cells arranged in rows coupled by access lines (which may be referred to herein as word lines or select lines) and columns coupled by sense lines (which may be referred to herein as digit lines or data lines). Although the memory array 110 is shown as a single memory array, the memory array 110 can represent a plurality of memory arrays arraigned in banks of the memory resource 103.

The memory resource 103 includes address circuitry 106 to latch address signals provided over an interface 104. The interface can include, for example, a physical interface (e.g., a data bus, an address bus, and a command bus, or a combined data/address/command bus) employing a suitable protocol. The physical interface can also include a memory slot to which a memory module comprising the memory resource 103 is coupled. The physical interface can also include an array area to which the memory resource 103 is directly coupled. Such protocol may be custom or proprietary, or the interface 104 may employ a standardized protocol, such as Peripheral Component Interconnect Express (PCIe), Gen-Z interconnect, cache coherent interconnect for accelerators (CCIX), or the like. Address signals are received and decoded by a row decoder 108 and a column decoder 112 to access the memory arrays 110. Data can be read from memory arrays 110 by sensing voltage and/or current changes on the sense lines using sensing circuitry 111. The sensing circuitry 111 can be coupled to the memory arrays 110. Each memory array and corresponding sensing circuitry can constitute a bank of the memory resource 103. The sensing circuitry 111 can comprise, for example, sense amplifiers that can read and latch a page (e.g., row) of data from the memory array 110. The I/O circuitry 107 can be used for bi-directional data communication with the host 102 over the interface 104. The read/write circuitry 113 is used to write data to the memory arrays 110 or read data from the memory arrays 110. As an example, the read/write circuitry 113 can comprise various drivers, latch circuitry, etc.

Control circuitry 105 decodes signals provided by the host 102. The signals can be commands provided by the host 102. These signals can include chip enable signals, write enable signals, and address latch signals that are used to control operations performed on the memory array 110, including data read operations, data write operations, and data erase operations. In various embodiments, the control circuitry 105 is responsible for executing instructions from the host 102. The control circuitry 105 can comprise a state machine, a sequencer, and/or some other type of control circuitry, which may be implemented in the form of hardware, firmware, or software, or any combination of the three. In some examples, the host 102 can be a controller external to the memory resource 103. For example, the host 102 can be a memory controller which is coupled to a processing resource of a computing device. Data can be provided to the memory array 110 and/or from the memory array via the data lines coupling the memory array 110 to the I/O circuitry 107.

In various instances, the memory resource 103 can be utilized to store input data, and allow for data processing, performance of complex algorithms/models, and support implementation of AI-based LLMs to perform intense data processing.

FIG. 2 illustrates a block diagram of an apparatus in the form of an actuator 220 in accordance with a number of embodiments of the present disclosure. The actuator 220 can include a system on a chip (SoC) 222, which can include a processing resource, a memory resource, and/or input/output (I/O) ports. The processing resource can be coupled to a memory resource 203 (e.g., a high memory capability memory resource), such as a NAND memory resource, SSD memory resource, or a DRAM memory resource, among others.

The actuator 220 can include a plurality of sensors, such as internal sensors 226 and external sensors 224. These sensors may include, for instance, internal and/or external temperature sensors, weight sensors, timing sensors, pressure sensors, etc. The internal sensors 226 and the external sensors 224 can gather data for use in determining an appropriate torque for the actuator 220. In some examples, the memory resource 203 can include an additional sensor, for instance, a temperature sensor, to monitor temperature of the memory resource 203 and/or actuator coils. This information allows for anticipatory adjustments to be made before data is lost due to overheating of the memory resource 203. In other examples, the internal sensor 226 is an encoder that collects information associated with positions of components (e.g., a shaft), and the external sensor 224 is an inertial measurement unit (IMU) sensor.

In some examples, the actuator 220 can be located on a device, such as a locomotion device including, but not limited to, a prosthetic device, an exoskeleton device, a drone, a robot (e.g., a four-legged robot), etc. Locomotion devices may be used for rehabilitation, training, physical therapy, or to act in place of a missing or non-functional body part, among other uses. Locomotion devices can be used to replicate human motion and/or add extra tension or weight to the motion (e.g., for rehabilitation or athletic training).

The memory resource 203 and/or SoC 222 can include instructions written thereon and executable by the processing resource to cause an output torque for the actuator 220 based on locomotion input data associated with a device (e.g., the locomotion device). The locomotion input data, for instance, can include sensor data received from humans running, walking, and otherwise moving on sensor plates, height information, gender information, weight information, gait information, etc. Cameras and other on-body sensors may also be utilized to gather location input data.

Using the locomotion input data, the actuator can utilize its processing capabilities to analyze the data and output a torque recommendation for the actuator. For instance, a user with stronger legs may need a higher torque output from the actuator than a small child with weaker legs. Other factors including motion, weight, height, gender, gait characteristics, etc. can affect the torque output prediction, which will be discussed further herein.

In some examples, the instructions can be stored on a machine readable medium. The machine readable medium can be communicatively connected to a processor resource by a communication path. In some examples, a communication path can include a wired or wireless connection that can allow communication between devices and/or components within a single device. As used herein, the processor resource can include but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions. In some examples, the processor resource utilizes a non-transitory computer-readable medium storing instructions, that, when executed, cause the processor resource to perform corresponding functions.

The machine readable medium may be electronic, magnetic, optical, or other physical storage device that stores executable instructions. Thus, a non-transitory machine-readable medium (MRM) (e.g., machine readable medium) may be, for example, a non-transitory MRM comprising Random-Access Memory (RAM), read-only memory (ROM), an Electrically Erasable Programmable ROM (EEPROM), a storage drive, an optical disc, and the like. The machine readable medium may be disposed within a controller and/or computing device. In this example, the executable instructions, can be “installed” on the device. Additionally, and/or alternatively, the machine readable medium can be a portable, external, or remote storage medium, for example, which allows a computing system to download the instructions, from the portable/external/remote storage medium. In this situation, the executable instructions may be part of an “installation package”.

The instructions can be executable to cause the determined torque to be provided the actuator device 220 device, data associated with performance of the device to be obtained, and smoothing of the locomotion of the device using a model and based on the performance. The model, for example, may be an IDA-PBC model or a combination of dynamic mathematical models.

For instance, input data can be received from a plurality of sources. The input data can be encrypted, in some examples. Sources can include a database of generic human movement, gait, and/or movement information, patient health information sources (e.g., personal tracking devices, personal medical devices, patient health data, etc.), providers (e.g., health care provider data), and environmental information sources (sensors, cameras, motion detectors, etc.). For instance, the database of generic information may include common walking patterns and average torque outputs for different human joints.

The model can be used to analyze the input data and determine an appropriate torque output for the actuator. As the model continues to learn and perform iteratively, additional determinations and adjustments can be made to smooth the locomotion of the device. For instance, if there is too large a gap between two consecutive torque outputs, both may be adjusted to avoid uncomfortable or unsafe transitions in movement.

The data associated with performance of the device, in some examples, can be written to a memory resource 203, a cloud service, or a combination thereof. For instance, a cloud service can serve as additional storage, and additional data may be added to the cloud service from other humans, allowing for an increase in information. The additional data may be written to the memory resource for use in personalized torque determinations for the user of the locomotion device on which the actuator 220 is housed. The cloud service may also be accessed by healthcare providers and medical device developers to improve functionality of other locomotive devices.

As noted, the actuator 220 can include a temperature sensor or temperature sensors (e.g., the internal sensor 226). The temperature sensor can be associated with the memory resource in some instances. In some examples, the instructions can be executable to cause reduction of the output torque responsive to the temperature sensor detecting a temperature above a particular threshold. For instance, a temperature inside an actuator may reach approximately 85-100 degrees Celsius. Should the temperature rise above the particular threshold (e.g., 95 degrees Celsius, 100 degrees Celsius, 105 degrees Celsius, etc.), the output torque can be lowered to reduce a risk of damage to the memory resource, processing resource, and/or other actuator components. Additional techniques may be used to cool the actuator device may also be used in response to the temperature rising above the particular threshold including the use of heat sinks or other cooling devices.

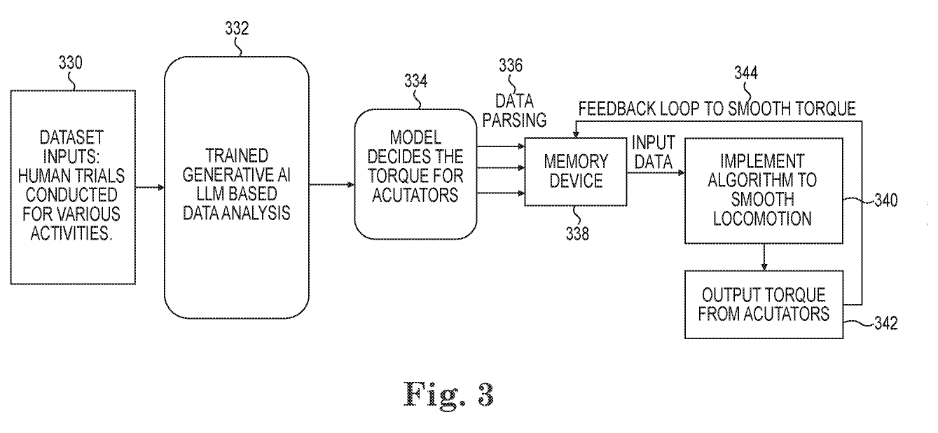

FIG. 3 illustrates an example flow diagram of a method for torque determination in accordance with a number of embodiments of the present disclosure. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by the control circuitry (e.g., controller) 105 and/or by the host 102 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At box 330, data inputs can be created, for instance by conducting human trials for various activities. These trials can include humans running, walking, or performing other activities on sensor plates, using sensor cameras and on-person devices, gait testing and measuring, and/or other information-gathering approaches.

At box 332, a trained model, such as a generative AI LLM-based model can be used to analyze the input data. Other model types may be used as well, such as those that include the use of images. The model can be trained using self-supervised learning on a large amount of input data (e.g., as gathered in human trials or from open-source data) and can be used to analyze data and extract valuable information, enhancing data analysis of large volumes of data. The LLM may also be multi-modal, having the ability to process or generate images and audio.

Training the model can be performed using complex algorithms such as task dependent controllers that track predefined trajectories and/or energy-shaping based models that control strategy that stabilizes mechanical systems by manipulating their energy. Example models used to replicate human locomotion may include body-weight support controllers, classical periodic boundary conditions (PBC), and/or IDA-PBC, among others. Further, voice-controlled systems can be established by combining AI LLM models with controllers.

At box 334, a same or different model can be used to determine a torque for associated actuators. For instance, based on the analysis performed at box 332, a torque suited for the particular human activity and the particular actuator can be determined. For example, based on the human user’s information, as well as the analysis performed at box 332, the model (e.g., machine learning model) can determine a proper torque is 10 Newton meters of torque.

The torque can be input into the memory resource at 338, and data can be parsed as shown at 336. As more and more data is received, it can be parsed into a structured, readable format for further analysis and use. At box 340, data stored in the memory resource 338 (e.g., parsed data) can be input into another model (e.g., smoothening algorithm) to smooth locomotion associated with the actuator. The data can be smoothed based on what has been learned through multiple runs of the models and based on performance results of the actuators. At box 342, actual output torque from the actuators can be determined, and sent back to the memory resource 338 at 344 to further smooth the locomotion associated with the actuator and torque. For instance, the process can be performed iteratively, and the performance of the actuator can improve, as the torque output is better defined and more precise as more data is analyzed by the models.

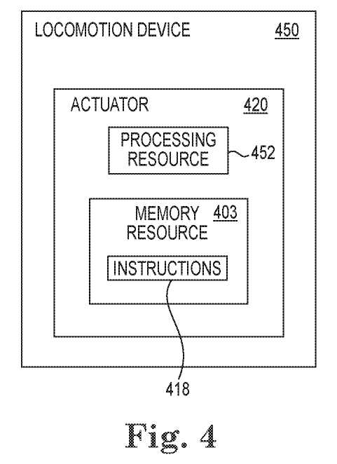

FIG. 4 illustrates a block diagram of a system including a locomotion device 450 with an actuator 420 in accordance with a number of embodiments of the present disclosure. The locomotion device 450 may be a prosthetic device, an exoskeleton device, a drone, or a four-legged robot, among others. The actuator 420, for example, can be a high-torque actuator, such as those used in the aforementioned locomotion devices, among others.

The actuator 420 can include a processing resource 452 and a memory resource 403 having instructions 418 written thereon and executable by the processing resource 452. The instructions 418, in some examples, can be executable to receive input data associated with use of the locomotion device and determine a torque for the actuator to apply to the locomotion device based on the input data and using a first model.

The input data, for example, can include weight data, height data, gender data, knee liftoff angle data, ankle liftoff data, or a combination thereof. This data can be used to personalize and improve performance of the locomotion device. In some examples, pre-existing data sets can be utilized in addition to, or instead of, the weight data, height data, gender data, knee liftoff angle data, ankle liftoff data, etc.

The instructions 418, in some examples, can be executable to apply the determined torque to the locomotion device and smooth, using a second model, locomotion of the locomotion device based on the determined torque and additional data stored in the memory resource. For instance, as the actuator 420 is turned on, it provides torque based on what previous data processing has determined, but the locomotion can be smoothed as the model(s) are run and appropriate output torque values are determined. The smoothing may be sinusoidal in some examples.

The second model, in some examples, can be updated based on additionally received input data and results of smoothing the locomotion device 450. In some examples, the actuator 420 and associated trained machine learning model can include continuous learning of the machine learning model and re-calibration of the machine learning model. This allows for the torque to be smoothed as more information is gathered and the model trains further.

In some examples, the instructions 418 can be executable to cause communication between the actuator 420 and a different actuator of the locomotion device 450. For example, if the actuator 420 is located on a locomotion device 450, such as the knee joint of a leg prosthetic, the actuator 420 (e.g., a controller of the actuator 420) may be in communication with a different actuator (e.g., a controller of the different actuator) at an ankle joint of the locomotion device 450.

In some examples, the system can include a body weight support controller. Body weight supports can be used for rehabilitation purposes and to help patients regain the ability to walk after conditions such as strokes. The body weight support controller compensates for different forces (e.g., vertical forces) and maintains desired tension and/or torque of the body weight support.

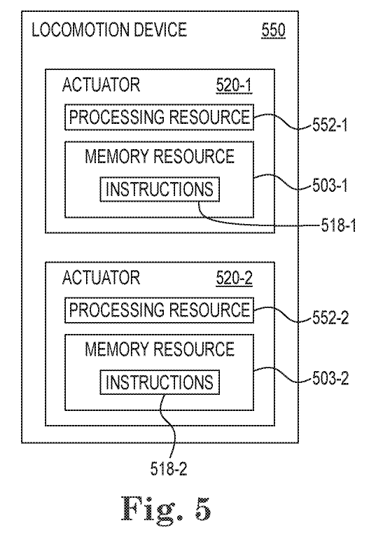

FIG. 5 illustrates a block diagram of a system including a locomotion device 550 with actuators 520-1, 520-2 in accordance with a number of embodiments of the present disclosure. The locomotion devices 550 may be a prosthetic device, an exoskeleton device, a drone, or a four-legged robot, among others. The actuators 520-1, 520-2, for example, can be high-torque actuators, such as those used in the aforementioned locomotion devices, among others. While two actuators 520-1, 520-2 are illustrated in FIG. 5, more or less than two actuators may be present on the locomotion device 550. For example, a full leg prosthetic device may include three actuators, with one located at each joint (e.g., hip, knee, ankle).

The actuator 520-1 can include a processing resource 552-1 and a memory resource 503-1 having instructions 518-1 written thereon and executable by the processing resource 552-1. The actuator 520-2 can include a processing resource 552-2 and a memory resource 503-2 having instructions 518-2 written thereon and executable by the processing resource 552-2. The actuator 520-1 may be associated with a first portion of the locomotion device 550, such as a knee joint of a prosthetic device. The actuator 520-2 may be associated with a second portion of the locomotion device 550, such as an ankle joint the prosthetic device. Other portions and combinations of the actuators 520-1, 520-2 are possible. In some examples, the first portion of the locomotion device 550 and the second portion of the locomotion device 550 may require different torque output values (e.g., knee joint vs. ankle joint).

The instructions 518-1 (e.g., first instructions) can be executable by the processing resource 552-1 (e.g., first processing resource) to cause a first torque for the actuator 520-1 to apply to a first portion of the locomotion device 550 to be determined, application of the determined first torque to the first portion of the locomotion device 550, and smoothing of locomotion of the first portion of the locomotion device 550 based on the determined first torque and additional data stored, for instance in the first memory resource 503-1 or a different memory resource.

The instructions 518-2 (e.g., second instructions) can be executable by the processing resource 552-2 (e.g., second processing resource) to cause a second torque for the actuator 520-2 to apply to a second portion of the locomotion device 550 to be determined, application of the determined second torque to the locomotion device 550, and smoothing locomotion of the second portion of the locomotion device 550 based on the determined second torque and additional data stored, for example in the second memory resource 503-2 or a different memory resource.

In some examples, the first memory resource 503-1 and the second memory resource 503-2 are a same memory resource, and/or the first processing resource 552-1 and the second processing resource 552-2 can be in communication with either or both memory resources 503-1, 503-2. For example, a single memory resource can execute instructions for both processing resources 552.

In some examples, the first memory resource 503-1 is communicatively coupled to the second memory resource 503-2, and the second portion of the locomotion device 550 is smoothed in conjunction with the smoothing of the first portion of the locomotion device 550. This takes into consideration different joints of the locomotion device 550 potentially needing different torque outputs, and it allows for further personalization of the locomotion device. In addition, if a first portion of the locomotion device 550 begins to overheat and torque is adjusted, torque can be adjusted at the second portion of the locomotion device 550 in response, so the portions can work smoothly together.

In some instances, the first instructions 518-1 and the second instructions 518-2 are executable to smooth the first portion of the locomotion device 550 and the second portion of the locomotion device 550 using a machine-learning model using data stored in the first memory resource 503-1 and the second memory resource 503-2, respectively. When the portions are smoothed, in some examples, the actuators 520 can communicate with one another to smooth the entire locomotion device 550.

The first memory resource 503-1 and the second memory resource 503-2, in some examples, are communicatively coupled to a cloud service. Data collected, as well as input, into the memory resources 503, can be saved to the cloud service. As more data is gathered, the models can improve by learning from the newly collected data, as well as additional data gathered from other sources.

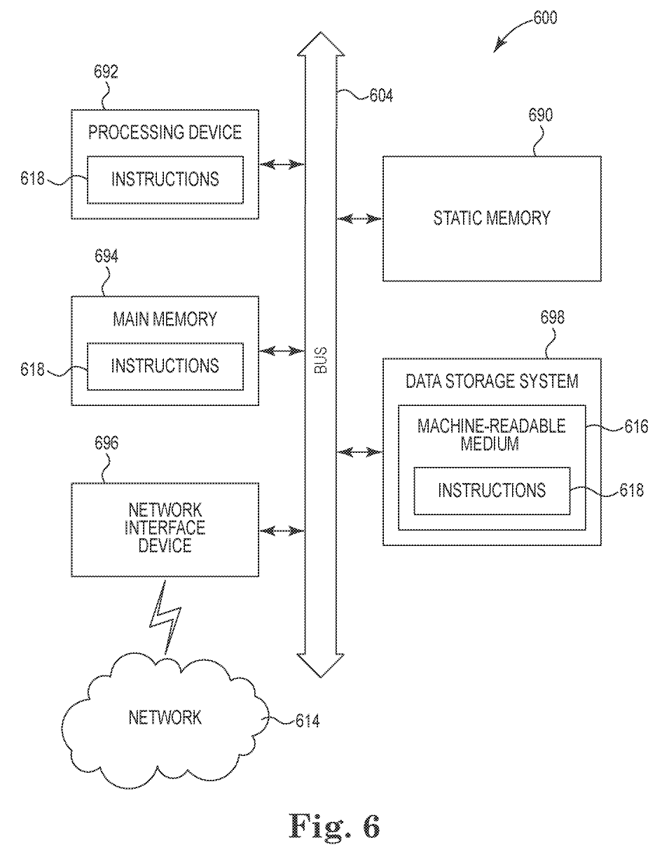

FIG. 6 illustrates an example machine of a computer system 600 within which a set of instructions, for causing the machine to perform various methodologies discussed herein, can be executed. In various embodiments, the computer system 600 can correspond to a system (e.g., the computing system 100 of FIG. 1) that includes, is coupled to, or utilizes a memory sub-system (e.g., the memory resource 103 of FIG. 1) or can be used to perform the operations of a controller (e.g., the controller circuitry 105 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 692, a main memory 694 (e.g., read-only memory (ROM), flash memory, dynamic random access memory (DRAM) such as synchronous DRAM (SDRAM) or Rambus DRAM (RDRAM), etc.), a static memory 690 (e.g., flash memory, static random access memory (SRAM), etc.), and a data storage system 698, which communicate with each other via a bus 604.

Processing device 692 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 692 can also be one or more special-purpose processing devices such as an application specific integrated circuit (ASIC), a field programmable gate array (FPGA), a digital signal processor (DSP), network processor, or the like. The processing device 692 is configured to execute instructions 618 for performing the operations and steps discussed herein. The computer system 600 can further include a network interface device 696 to communicate over the network 614.

The data storage system 698 can include a machine-readable storage medium 616 (also known as a computer-readable medium) on which is stored one or more sets of instructions 618 or software embodying any one or more of the methodologies or functions described herein. The instructions 618 can also reside, completely or at least partially, within the main memory 694 and/or within the processing device 692 during execution thereof by the computer system 600, the main memory 694 and the processing device 692 also constituting machine-readable storage media.

In one embodiment, the instructions 618 include instructions to implement functionality corresponding to the host 102 and/or the memory resource 103 of FIG. 1. While the machine-readable storage medium 616 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

As used herein, “a number of” something can refer to one or more of such things. For example, a number of memory resources can refer to one or more memory resources. A “plurality” of something intends two or more. Additionally, designators such as “N,” as used herein, particularly with respect to reference numerals in the drawings, indicates that a number of the particular feature so designated can be included with a number of embodiments of the present disclosure.

As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An actuator device, comprising:
a processing resource; and
a memory resource having instructions written thereon and executable by the processing resource to cause:
an output torque for the actuator device to be determined based on locomotion input data associated with a locomotion device;
the determined output torque to be provided to the actuator device;
data associated with performance of the locomotion device to be obtained; and
locomotion of the locomotion device to be smoothed using a model and based on the performance.

2. The actuator device of claim 1, wherein the model is an interconnection and damping assignment passivity-based control (IDA-PBC) model.

3. The actuator device of claim 1, further comprising the instructions executable by the processing resource to cause the data associated with performance of the device to be written to the memory resource, a cloud service, or both.

4. The actuator device of claim 1, comprising a temperature sensor associated with the memory resource.

5. The actuator device of claim 4, comprising the instructions executable by the processing resource to cause reduction of the output torque responsive to the temperature sensor detecting a temperature above a particular threshold.

6. The actuator device of claim 1, wherein the memory resource is at least one of a NAND flash memory resource, a solid-state drive (SSD) memory resource, and a dynamic random-access memory (DRAM) memory resource.

7. A system, comprising:
a locomotion device; and
an actuator of the locomotion device, comprising:
a processing resource; and
a memory resource having instructions written thereon and executable by the processing resource to cause:
a torque for the actuator to apply to the locomotion device to be determined based on input data associated with use of the locomotion device and using a first model;
the determined torque to be applied to the locomotion device; and
locomotion of the locomotion device to be smoothed, using a second model, based on the determined torque and additional data stored in the memory resource or a different memory resource of the actuator.

8. The system of claim 7, comprising the instructions executable by the processing resource to cause communication between the actuator and a different actuator on the locomotion device.

9. The system of claim 7, wherein the input data comprises weight data, height data, gender data, knee liftoff angle data, ankle liftoff data, or a combination thereof.

10. The system of claim 7, wherein the actuator is a high-torque actuator.

11. The system of claim 7, further comprising a body weight support controller.

12. The system of claim 7, wherein the locomotion device is a prosthetic device.

13. The system of claim 7, wherein the locomotion device is an exoskeleton device.

14. The system of claim 7, comprising the instructions executable by the processing resource to cause updating of the second model based on additionally received input data and results of smoothing the locomotion device.

15. A system, comprising:
a locomotion device; and
a first actuator of the locomotion device, comprising:
a first processing resource; and
a first memory resource having first instructions written thereon and executable by the first processing resource to cause:
a first torque for the first actuator to apply to a first portion of the locomotion device to be determined;
the determined first torque to be applied the first portion of the locomotion device; and
locomotion of the first portion of the locomotion device to be smoothed based on the determined first torque and first additional stored data; and
a second actuator of the locomotion device, comprising:
a second processing resource; and
a second memory resource having second instructions written thereon and executable by the second processing resource to cause:
a second torque for the second actuator to apply to a second portion of the locomotion device to be determined;
the determined second torque to be applied to the second portion of the locomotion device; and
locomotion of the second portion of the locomotion device to be smoothed based on the determined second torque and second additional stored data.

16. The system of claim 15, wherein:
the first memory resource is communicatively coupled to the second memory resource; and
the second portion of the locomotion device is smoothed in conjunction with the smoothing of the first portion of the locomotion device.

17. The system of claim 15, wherein the first instructions and the second instructions are executable to cause smoothing of the first portion of the locomotion device and the second portion of the locomotion device using a machine-learning model and data stored in the first memory resource and the second memory resource.

18. The system of claim 15, wherein the first memory resource and the second memory resource are communicatively coupled to a cloud service.

19. The system of claim 15, wherein the first memory resource and the second memory resource are a same memory resource.

20. The system of claim 15, wherein the first additional data is stored in the first memory resource, and the second additional data is stored in the second memory resource.
